(19) United States
(12) Patent Application Publication
(10) Pub. No.: US 2003/0115251 A1
(43) Pub. Date: Jun. 19, 2003

(54) Peer data protocol

(76) Inventors: Jason A. Fredrickson, Pasadena, CA (US); Arlo M. Belshee, Pasadena, CA (US); William R. Williams, Monrovia, CA (US); Augustus Saunders, Hollywood, CA (US)

Correspondence Address: INTELLECTUAL PROPERTY LAW OFFICE, 1901 S. BASCOM AVENUE, SUITE 660, CAMPBELL, CA, 95008, US

(21) Appl. No.: 10/076,162

(22) Filed: Feb. 13, 2002

Related U.S. Application Data
(60) Provisional application No. 60/270,821, filed on Feb. 23, 2001.

(51) Int. Cl. G06F 9/46; G06F 9/00; G06F 15/16

(52) U.S. Cl. 709/201

(57) ABSTRACT

A Peer Data Protocol (PDP)(10) for securely storing a data object (20) on a peer-to-peer network (50) of nodes (14). An owning node (16) owns the data object (20), possessing nodes hold the data object (20), an indexing node (68) facilitates overall operation of the PDP (10), and a backup node (66) may optionally be provided to ensure that the data object (20) is available even when the possessing nodes (18) holding it are not. The possessing nodes (18) securely store the data object (20) remote from its owning node (16), yet themselves have no access to the contents of the data object (20) unless granted such by the owning node (16). To enhance the security of this scheme the possessing nodes (18) may be chosen from among a large pool of neighbor nodes (56), the data object (20) may be piece-wise stored across multiple of the possessing nodes (18), and the pieces may be share-wise stored across multiple of the possessing nodes (18) and analyzed for integrity before later use.

### CROSS-REFERENCE TO RELATED APPLICATIONS

This application claims the benefit of U.S. Provisional Application No. 60/270,821, filed Feb. 23, 2001.

| | |
|---|---|
| 10 | PDP |
| 12 | user |
| 14 | node |
| 16 | owning node |
| 18 | possessing node |
| 20 | data object |
| 20a-c | data pieces |
| 20a1, 20a2, 20a3 | data shares |
| 20b1, 20b2, 20b3 | data shares |
| 20c1, 20c2, 20c3 | data shares |
| 22 | operation node |
| 24 | message |
| 30 | graph |
| 32 | vertex |
| 34 | edges |
| 40 | graph |
| 42 | vertex |
| 44 | edges |
| 46 | weighted edges |
| 50 | network |
| 52 | given node |
| 54 | connections |
| 56 | neighbor node |
| 62 | peer node |
| 64 | server node |
| 66 | backup node |
| 68 | indexing node |
| 70 | node index |
| 72 | data index |
| 110 | data block |
| 112 | signature |
| 114 | patch |
| 116 | permissions |
| 118a-e | fields |
| 200 | read process |
| 202-222 | step |
| 300 | write process |
| 302-332 | step |

### TECHNICAL FIELD

The present invention relates generally to the security of data stored in large computer networks, such as the Internet, and more particularly to storing secure, reliable data on such networks in a distributed fashion.

### BACKGROUND ART

Storing and distributing secure and reliable data on the Internet is an open problem today. Contemporary advances in security for this purpose focus on either protecting electronic objects when transmitted on the Internet, or when stored locally, but not both. For example, it is possible to encrypt email, but it must be unencrypted to be read. Likewise secure and redundant local storage mechanisms protect documents from remote sabotage and from equipment failures, but are unable to transmit documents. Items such as wills, deeds and other legal documents must be secure in both their transmission and local storage.

Digital objects that are as secure as physical objects have tremendous economic value. They allow operational changes that reduce or virtually eliminate tremendous costs, and provide new, faster and more efficient ways to operate. They also reduce the current “acceptable” costs or lost revenue for industries which are digital today. Digital objects also open new opportunities, such as digital coupons from merchants, as more and more of our activities become digital.

To better appreciate the problem, an understanding of current networking technology is useful. Today's computer networks rely on a basic backbone of technology known as TCP/IP and DNS. TCP/IP is an acronym for “Transmission Control Protocol/Internet Protocol,” a pair of communications protocols which (respectively) allow two computers to establish a connection and stream data packets to each other, and allow computers to create such packets. DNS is an acronym for “Domain Name Service,” a system which translates domain names into IP addresses, which are used in the aforementioned protocols. These two pieces of technology allow computers to communicate with each other by means of a connectionless transfer of information. Connectionless paradigms rely on breaking information to be transferred into multiple smaller packets and sending each packet to the destination individually over an intervening network, without relying on a dedicated connection between the two machines.

A data storage solution should desirably be designed to function in the same environment as current networking technologies, and to utilize the same TCP/IP and DNS backbones as other modern techniques. This removes any technology-based market adoption barrier. However, it is important to note that any fully-connected transfer of information (such as is utilized by digital mobile phones) is more secure than an equivalent connectionless system. Therefore, an implementation on a mobile platform should also be shown to be as secure as the original design.

Consider the current network paradigms. The World Wide Web and other modern networks are primarily extensions of a single basic network paradigm, the Local Area Network (LAN). A LAN is a network of computers that are near each other (usually in the same building). Each node in a LAN has its own processor and executes its own programs, but is able to access data and devices anywhere on the network.

A key feature of local area networks is that each node or device “owns” any data stored locally, i.e., on the same machine. Each node in the LAN is responsible for modifying and moving any data stored locally. Security is implemented by having a particular node refuse access to its data to particular other nodes.

A group of connected LANs is a Wide-Area Network, or WAN. WANs usually have slower connections between individual LANs, and security is usually implemented by having a particular LAN refuse access to its data to any node of another LAN. The Internet is nothing more than a vast, high-speed wide-area network.

The World Wide Web is a set of data stored on the Internet that is intentionally made available to all nodes. Such data is stored on large central servers, which are configured to allow any node access to their data. As such, data on the World Wide Web is inherently insecure: the systems designed to make the data available are designed not to ensure its integrity.

Storing data securely on the World Wide Web has historically proven very expensive. However, the technology underlying the Web includes the seeds of a much more efficient means of storage and distribution of data, because every computer on the Internet can participate. Ironically, while the servers are heavily taxed to support the load, at any given time the vast majority of computers connected to the Internet have spare resources. In fact, studies indicate that 99% of the processor power on the Internet is currently being wasted. Historically, concerns about security and reliability have prevented use of these computers for secure applications.

An alternate paradigm to the World Wide Web which is currently being explored is peer-to-peer networking, in which individual smaller nodes supply data directly to each other without the need for massive central servers. These systems unfortunately do nothing to protect data integrity. No modern network paradigms intrinsically protect the security and integrity of the data that they manipulate. These paradigms rely on the assumption that sensitive or important data will be encrypted before being placed on the network.

Consider current secure systems and modern security paradigms. Modern security paradigms are primarily encryption-based. Two basic forms of security encryption are known to be viable and are used to protect data today: one-time pads and high-digit encryption.

One-time pads are the only provably “unbreakable” form of encryption known to exist. By using a separate encryption key for each message, this system guarantees that an eavesdropper cannot decipher the message.

The basis for the security of a one-time pad system is that any given encrypted string has an equal chance of decrypting to any message string of the same length. For example, the encrypted message “oG59(SD#$%in6V2#” could have the possibilities: “Bank #779-424-33”; “Bank #654-098-14”; or “The bird is ill!”. It thus becomes impossible to decipher any message encrypted with a one-time pad. However, in order to maintain security, each message must utilize a different, unique, totally random pad, or the encryption quickly fails.

Unfortunately, because each message requires a separate key which must be known to both the sender and the recipient, there is substantial overhead associated with the use of one-time pads. This overhead prevents the system from being used in modern communications networks.

High-digit encryption techniques rely on the proven difficulty of solving particular mathematical problems (“hard” problems; e.g., problems such as prime-number factorization and the discrete logarithm problem). By basing an encryption key on such a hard problem, the system is able to transmit messages without fear that the message might be decrypted. In short, in order to decrypt such a message, the attacker must expend massive computational time to determine the encryption key by trial-and-error (i.e., use a “brute-force” approach).

The amount of time which a brute-force approach requires depends on the size of the encryption key. In short, by adding an extra digit to the key, the time required to break the encryption is increased by a constant multiplicative factor (doubling, tripling, etc.), while the time necessary to encrypt and decrypt with the key is increased by a constant additive factor. Thus, increasing the key length makes the encryption substantially more difficult to break. Modem cryptosystems utilize 1024 or 2048 bits per key to ensure security.

Two forms of high-digit encryption are used in modern cryptosystems: symmetric and asymmetric. Symmetric cryptosystems (also known as “private-key” systems) utilize a single key which is known to the sender and the receiver, and must be kept secret from all third parties. Asymmetric cryptosystems (also known as “public-key” systems) utilize a pair of keys, one of which (the private key) is known only to the message recipient, the other of which (the public key) may be distributed freely. Messages may be encrypted with the public key, but may only be decrypted with the private key, allowing far greater flexibility. Most cryptosystems in use today are asymmetric systems.

Modem networks make use of several different encryption schemes. These methods are typically selected based on speed of execution, availability, security, and features. Several of the most popular encryption schemes are outlined below.

The Digital Encryption System (DES) was designed in the 1970s by IBM and adopted by the Federal government as an encryption standard. DES is a symmetric cryptosystem which makes use of a 56-bit key for security. Because DES is a block-cipher cryptosystem, it is extremely fast. Unfortunately, this system's fixed key length renders it vulnerable to specialized brute-force attacks which modern machines can successfully complete in a matter of minutes or hours. Therefore DES is currently considered obsolete and will be replaced as a federal standard in 2002.

RSA is another scheme. This first practical public-key cryptosystem was developed in 1977. RSA is currently built into operating systems produced by Sun, Novell, Apple, and Microsoft, and is considered secure for key lengths of 1024 bits and above (extremely sensitive information is usually encrypted with 2048 bits). RSA's security is based on the difficulty of the prime factorization problem. However, RSA's increased security over DES comes at a substantial price: this cryptosystem is between 100 and 1000 times slower to encrypt or decrypt than DES.

Because of this substantial speed difference, RSA is often used in conjunction with DES or other block-cipher cryptosystems. A message is encrypted with DES using a randomly generated key. The key is then encrypted with RSA's public key and the encrypted key and message are sent to the recipient. The recipient uses the RSA private key to decrypt the random DES key, then uses that key to decrypt the message.

Advanced Encryption System (AES) and Rijndael are the last schemes we will consider here. The National Institute of Science and Technology's (NIST) proposed replacement for the aging DES standard is AES. NIST has selected an algorithm named Rijndael for the AES standard, and has approved its use for federal agencies. Rijndael is an asymmetric cryptosystem which is fast, flexible, and secure. Although it has not been as extensively tested as either RSA or the RC5/RC6 family of cryptosystems, it has been demonstrated to be secure if properly implemented and is small enough to function on smartcards and other small items. While federal agencies will not be required to use Rijndael exclusively, it is expected to become one of their primary tools for protecting sensitive data (“sensitive” data is not classified; classified data is protected by undisclosed encryption systems).

The modern network paradigms have been retrofitted with secure cryptosystems in an attempt to insure data integrity and data security. These systems are generally designed to maintain data security in one direction only, and are usually intended to secure either messages or data storage.

Several popular secure network systems are outlined as examples below. These systems are in widespread use by corporations, but only Secure Socket Layer (SSL) has achieved wide acceptance by the general public. Most consumers today are not aware that they make use of SSL on a regular basis when browsing ecommerce sites or other making other secure transactions.

SSL enables most “standard” network transaction systems (telnet, ftp, http, etc.) to take place in a secure fashion. However, it is optimized for http (the underlying networking paradigm of the World Wide Web). SSL makes use of RSA (and other similar systems) to ensure that messages sent via secure http and secure telnet are protected. SSL is implemented at the socket layer of the computer: data is encrypted as it is passed across the network, but is unencrypted (and thus unprotected) when actually residing locally on the machine at either end. Most “secure servers” found on the World Wide Web today make use of SSL to protect sensitive data (e.g., credit card numbers) sent by website visitors.

Pretty Good Privacy (PGP) was designed primarily as a public-key encryption scheme intended for use as an email protection system. Email messages may be encoded with a recipient's public key and decoded with the private key upon receipt. PGP is usually implemented in the email program itself, allowing users to encrypt emails before they are sent across the network. Emails may thus remain encrypted while stored locally. However, PGP is not implemented as a message transmission system—explicit user action is required. PGP is often used to protect sensitive emails from being read en route, but is not useful when attempting to protect received emails after they are decoded.

Virtual Private Networking (VPN) allows nodes to connect to local area networks without being in close physical proximity. It uses a strong cryptosystem to replace the security offered by physical wiring in a traditional LAN, so that WANs can exist as though they were a single LAN. Obviously, this enables users to make use of data and services available on the LAN as if they were in the building, without the overhead and insecurity of the WAN. Like SSL, VPN is implemented in the communications layers. That is, data is only encrypted during transit and VPN is no more and no less secure than any LAN.

Local Node Security is our final example here of modern security paradigms. This is scheme is found in the so-called local data security arena and in products such as KREMLIN. These systems encrypt data which actually resides on the local node, only decrypting it when requested by the user. While nothing protects data stored on the local node from interference by a malevolent local user, the data is extremely well protected from external interference. This security is normally used on large server systems for protection of consumers' credit card numbers and other sensitive data.

An examination of existing transaction and data security systems will immediately reveal the primary strengths and weaknesses of the various systems in use. While most of these systems are very strong in their primary field, they often have weaknesses when attacked from another direction.

Transactional security systems such as SSL and VPN offer a great deal of protection from external eavesdropping and interference. Because these encrypt all communications between nodes, an external attempt to corrupt or pirate the information in those communications is limited to attacks on the cryptosystem itself. As noted above, this sort of attack is provably hard and will usually be impractical.

Local node security data security systems (e.g., KREMLIN) protect data from being modified or pirated on the local node, but do not permit secure transactions between machines unless the encryption key is shared. These systems are very powerful with respect to protecting large amounts of infrequently accessed data. A hybrid system such as PGP allows certain types of data to be protected, but has no effect on other data types.

Unfortunately, each of these prior art systems has a large flaw in its use. Systems such as SSL or VPN offer no protection from a malevolent user on the local node who wishes to modify, copy, or destroy data locally. Systems such as KREMLIN do not prevent data interception in transit; furthermore, if the type and location of the encrypted data is known, it may be directly attacked and deciphered. None of these systems (or even the systems working in concert) protect data while it is being used, because a malicious user is always capable of finding and attacking the data stored on the local node.

A primary goal of a solution needs to be to minimize server burden, while maintaining the reliability and security that system administrators and users have come to expect from client-server systems.

Let us first consider central server burdens. Most of the computing power on the Internet today is at the “edges” of the Internet, the individual computers belonging to end-users at home, work, or school. Most of that bandwidth, processor power, and storage is therefore unused at any given time. Using a peer-to-peer architecture enables taking advantage of these resources, thus reducing demands on the central server which runs a given application. The server can be reduced to the size required for administrative support of the application. For example, most application developers would still prefer centralized logon, indexing, and backup services. Frequently, these tasks are small compared with the actual data transactions.

Any data storage system must balance three primary requirements: reliability, scalability, and security. Reliability is usually ensured by providing massive redundancy on a fully controlled central facility. Scalability, however, is usually ensured through a widely distributed peer network that can take advantage of available resources at each node. Security is most effectively accomplished by protecting data behind mathematically difficult problems. Designing a system that fulfils all three requirements is a challenging task.

It is imperative that users be able to access their data with an extremely low failure rate. Any data storage system must have high reliability; standard centralized server solutions give roughly 99.9% uptime. A solution therefore must be similar, despite the fact that users' connections to the Internet are unreliable.

Although reliable, a central server solution has a single point of failure. If the server is malfunctions, none of the clients can do anything in the system. Central server operators incur considerable expenses providing backup power, backup servers, and backup communications to avoid costly downtime. A peer-to-peer approach, however, can avoid this problem because multiple peers can provide the same services.

Unfortunately, the average Internet user is actively connected to the Internet for approximately 15 hours per week, or 10% of the time. This means that if a user stores their data remotely and wants to read that data, he or she will likely find that their data is unavailable. For example, if a user stores a legal document on another peer, there is only a 10% chance that the document will be available at any future time.

The simplest solution to this problem would be an active reliability solution, similar to those developed for hard disks. Active reliability solutions keep track of the availability of data and take corrective action when that availability drops. Such systems are implemented in RAID arrays to provide data redundancy for today's mission-critical systems. The difficulty with such systems, however, is that as one data repository goes offline, other data repositories must be accessed to create a new repository that replaces the offline one. While this is simple within a single piece of hardware, such as a hard disk, it is more difficult in a distributed network, where every bit transported consumes available bandwidth—one of the limiting resources.

Unfortunately, an active reliability solution would require much more bandwidth than is generally available. This dictates that some other type of reliability solution must be used. The most common alternative is a passive reliability system: a system that stores many copies of the data and only needs a few of them to be online in order to recover the data. Unfortunately, this technique proves insufficient from a security and efficiency standpoint.

Exploiting patterns in users' behaviour in order to decrease the amount of redundancy required in the system could decrease the inefficiency of passive reliability. As an example, if we assume that the population of typical users (connected 10% of each day, or nearly two and a half hours) are consistently offline between say 10 PM and 6 AM each day, then those two hours are distributed over only 16 hours, not 24. If we assume that data accesses will only occur during those 16 hours, the chance that data will be recoverable rises to 15%.

Finally, without proper provision for administration needs, a peer-to-peer system would reduce reliability or add expense, because the administrators no longer have control over the system. A solution therefore must take this into account, identifying problems and allowing administrators to adjust the peer network accordingly.

To compete with client-server systems, a solution also needs to overcome the insecure nature of end-users' computers. Owners of large server installations generally secure their installations against outside attackers. In a client-server system, therefore, the owner has full control over the security of the machines that store the data. In a peer-to-peer system, we must assume no control over node security exists, and that therefore security will be very poor for any given node.

Environmental constraints are often as significant as the requirements for security and scalability. Currently, very few systems remain online with any significant uptime. This problem negatively impacts many current peer-to-peer products.

Since the entire population of the Internet fluctuates according to time of day, day of the week, and other factors, it is very difficult to predict whether any particular node will be online at a given time. However, by examining usage patterns throughout the day, it is possible to estimate the probability that a given node will be online at any given time, that is to consider overall user populations.

The first population consists of business machines, usually connected at the beginning of the workday and disconnected at the end. A second population consists of home computers that are activated primarily at the end of the school or work day and disconnected later in the evening. A third group is made up of those computers which are online at all times—servers, academic machines, etc. And a fourth population consists of the small number of machines that follow no set usage pattern.

Another difficulty that presents itself is the problem of population correlation. In peer-to-peer applications, many of the peer nodes for a given application will tend to come online and offline at the same times. Therefore, any change in usage patterns by an individual tends to result in inefficiency and failure.

In sum, present data storage protocols for use in network environments are lacking. They severely burden their central server resources. Their reliability is limited to that of those central resources, unless trade offs are acceptable, particularly as regards data security. Those resources are also notoriously not easily scaled, with that having high attendant cost and lag time to either grow or to shrink data storage capacity. In particular, however, the present schemes provide somewhat opposite extremes when it comes to security. The client-server paradigm is essentially a fortress model. Data is secure only when locked up in the fortress, and at great peril when elsewhere. Its utility is thus severely limited. In contrast, the peer-to-peer paradigm is based on trust; trust that the data will be stored, that it will not be tampered with (in all the myriad possible variations of tampering), and trust that it will be provided when needed. Clearly, an improved data storage protocol is needed.

### DISCLOSURE OF INVENTION

Accordingly, it is an object of the present invention to provide a data storage protocol that minimizes burden on central server resources yet which maintains or improves upon reliability, scalability, and security when storing data.

Briefly, one preferred embodiment of the present invention is a system for securely storing a data object. A owning node (e.g., computer) owns the data object. A number of neighbor nodes are provided, wherein the owning and neighbor nodes are distinct but are collectively members of a network in which they have peer-to-peer status. A number of possessing nodes then store the data object. These possessing nodes are a subset of the neighbor nodes, but since the owning node is not a possessing node secure storage of the data object away its owning node is achieved.

An advantage of the present invention is that it provides reliability with a hybrid central server and peer-to-peer approach, wherein central server unavailability may be covered by the availability of peer-to-peer based storage and the unavailability of peer-to-peer based storage may be covered by the availability of a central backup server.

Another advantage of the invention is that it also provides scalability with this hybrid approach, wherein data storage can inherently and flexibly grow or shrink as peer users enter and exit the system with the resources of their nodes.

Another advantage of the invention is that it has security approaching that of a client-server, by employing a novel data ownership-possession separation scheme that overcomes the insecure nature of end-users' computers.

And another advantage of the invention is the overall economic benefit it can provide. The central server resources used can be reduced to the size required for administrative support, such as logon, indexing, and backup services, with a notable attendant reduction in cost over traditional server based schemes. The peer-to-peer resources used in place of this are free, already existing and being under utilized.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended figures of drawings in which:

FIG. 1 is a schematic diagram depicting basic elements and concepts of the inventive Peer Data Protocol;

FIG. 2A (background art) is a schematic diagram depicting how the basic structure of any computer network (e.g., the Internet) can be viewed as a graph consisting of computers (e.g., the nodes of FIG. 1) located at vertices and network connections located at edges;

FIG. 2B (background art) is a schematic diagram depicting how, the network of FIG. 2A can be viewed as a separate graph if the backbone of the network is designed to allow data transfer transparently from any node to any other;

FIG. 2C (background art) is a schematic diagram depicting how, additionally, some of the edges in the graph may be weighted edges, according to virtual connection speed, bandwidth, and reliability;

FIG. 3 is a schematic diagram depicting how, a network of nodes and connections of the invention may be constructed atop the graph of FIG. 2B-C, such that the topology of the network most closely resembles that of a tree structure;

FIG. 4 is a schematic diagram depicting how the data objects of the invention may be stored in a highly structured fashion to permit version control, authentication, logical access, and security;

FIG. 5A-B are schematic diagrams depicting two simplified examples of storage of the data objects of FIG. 4;

FIG. 6 is a flow chart depicting a read process that may be used by the invention when an owning node wants to read a data object that it owns;

FIG. 7 is a flow chart depicting a write process that may be used by the invention when an owning node wants to write a data object; and

FIG. 8A-B are graphs depicting performance characteristics of the invention.

In the various figures of the drawings, like references are used to denote like or similar elements or steps.

### BEST MODE FOR CARRYING OUT THE INVENTION

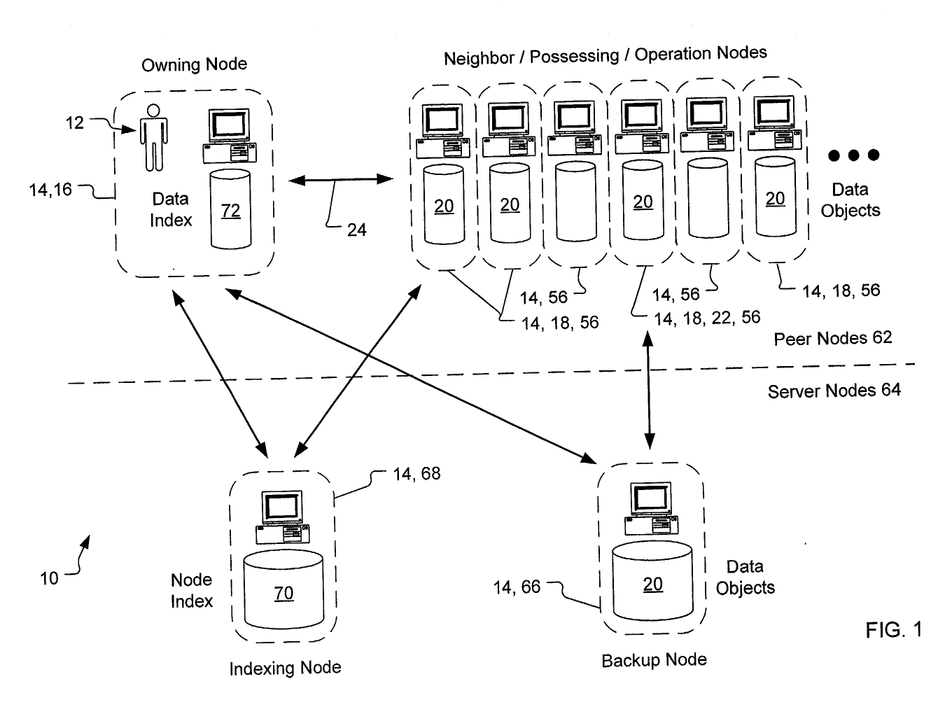

A preferred embodiment of the present invention is a peer data protocol. As illustrated in the various drawings herein, and particularly in the view of FIG. 1, this preferred embodiment of the invention is depicted by the general reference character 10.

FIG. 1 is a schematic diagram depicting basic elements and concepts of the inventive Peer Data Protocol (PDP 10). A key premise is that any user 12 might be able to corrupt his or her own node 14 and copy, modify, or destroy the data on it. Such an user 12 must be prevented from tampering with sensitive data, but should be able to own or use the data.

In order to prevent tampering, PDP 10 separates the concept of data ownership from that of data possession. It does not allow protected data to be both owned and possessed by the same node 14, and for this it distinguishes owning nodes 16 from possessing nodes 18. An owning node 16 owns a data object 20 but cannot directly copy or alter that data object 20 because it is not local. In contrast, a possessing node 18 possesses the data object 20, but does not know what the data object 20 is, or even if it is complete. Thus, a malicious user 12 (an owning user or otherwise) corrupting an owning node 16 would find nothing to copy, modify, or destroy, and the same user 12 corrupting a possessing node 18 would be unable to distinguish the data object 20 to modify it.

Separating the data objects 20 into multiple data pieces (e.g., data pieces 20a, 20b . . . ) and having each possessed by different possessing nodes 18 further improves data security. In order to steal the entire data object 20 a malignant user 12 must then find and corrupt multiple possessing nodes 18, a difficult problem.

Duplicating the data pieces of the data objects 20 into multiple piece copies and having those each possessed by different possessing nodes 18 can further improve data security. The duplicate piece copies for each data piece could then be compared to determine if data integrity had been compromised. This approach, however, is quite burdensome and the inventors have employed a more sophisticated one.

The data pieces are used as the basis for a secret sharing algorithm to create a number of data shares. These data shares (e.g., for data piece 20a, data shares 20a1, 20a2 . . . 20a20) are then each possessed by different possessing nodes 18. This concept, and one secret sharing algorithm particularly suitable for this, are described presently. Briefly, however, if the number of data shares is 20, when only three data shares are retrieved the data piece can be derived and when more than three data shares are retrieved the additional ones can be used to determine if data integrity has been compromised. The use of data shares for each data piece thus further improves data security in an efficient manner.

Summarizing, PDP 10 can provide security by separating the ownership of a data object 20 from possession of it, by further using piece-wise possession by multiple entities, and by further using share-wise possession on multiple entities and share analysis to verify data integrity.

PDP 10 thus may provide up to three tiers of protection. The first of these concepts is fundamental to PDP 10, and the latter two are optional. To facilitate discussion here the data objects 20 will be referred to, generally, and data pieces and data shares will be referenced only when aspects of the invention peculiar to them are being covered.

The following paradigm concepts and definitions are key to the design and specifications of the invention. PDP 10 separates data into two categories: hard data and soft data. The hard data is protected by PDP 10, as the data objects 20, whereas the soft data is merely normal digital data, as it is known today (when the term “data” is used elsewhere herein, without an accompanying modifier, it is assumed to refer to hard data). The soft data is unprotected and may be freely copied, moved, modified, deleted, etc.

The hard data is intrinsically associated with a set of permissions that dictates exactly what actions out of the set of all possible actions the owner of the data may take. Because the hard data can be controlled to never owned and possessed by the same node 14, these permissions are rigidly enforceable by the possessing nodes 18.

In order to protect the hard data, certain data transitions or modifications are completely disallowed. While the soft data may be converted to hard data, the hard data may never be converted fully to soft data; converting hard data to soft data would remove all security.

PDP 10 also separates applications into two categories: hard applications and soft applications. Soft applications interact with soft data, and have no restrictions on their functionality. All existing applications today may be thought of as soft applications. Hard applications interact with hard data, and must abide by the permissions associated with it. Certain types of applications may never exist as hard applications. Certain types of applications may never exist as hard applications.

As already touched upon, PDP 10 particularly separates the concepts of data ownership and data possession. A node 14 owns a data object 20 if it holds the rights and responsibilities for the creation, modification, movement, and/or destruction of that data object 20. The node 14 (the owning node 16) then is the only node 14 that is permitted to issue instructions regarding the data object 20; all other instructions are ignored. A node 14 (the possessing node 18) possesses data if it actually stores at least part of a data object 20. The possessing node 18 is responsible for obeying instructions regarding the data object 20 that originate from the owning node 16.

The embodiments of PDP 10 are based around a short list of unilateral principles. Firstly, as noted, data should not be owned and possessed by the same node. Thus, an owning node 16 is generally not capable of possessing a data object 20 which it owns. If the owning node 16 has rights and permissions to modify a data object 20 at its own behest, the data object 20 is not stored on the owning node 16. Any other node 14 which discovers an owning node 16 has disobeyed this rule can then alert its companion nodes 14.

Secondly, all operations should be handled by non-local nodes. Thus, an owning node 16 should not perform an operation on any data object 20 which it owns. If the owning node 16 has rights and permissions to move or modify the data object 20 (which is not stored on the owning node 16), all such operations must be performed by a possessing node 18 which holds the data object 20. All operations performed on the data object 20 by a possessing node 18, such that the data object 20 is stored locally on the possessing node 18, must be initiated by the owning node 16, which is not the possessing node 18. The possessing nodes 18 verify the identity of the owning node 16 and the validity of its ownership of the data object 20 by receiving instructions encrypted with the private key of the owning node 16. One or more of the possessing nodes 18 may be designated to act as operation nodes 22 and perform the operation. Redundant performance of operations and result comparison can further enhance security in PDP 10.

Thirdly, all the nodes propagate and obey centrally-dictated directives. Thus, a possessing node 18 is capable of verifying that a message 24 passed on by a node 14 is valid, and is capable of passing the message 24 on to all of its neighboring nodes 14. Additionally, the operation nodes 22 are capable of modifying the data object 20 in accordance with the directives contained within a valid instance of the message 24, and shall do so without fail.

In addition to the primary directives underlying PDP 10, laid out above, two basic assumptions are made regarding security. Firstly, a user 12 is assumed to be capable of trivially corrupting his or her own node 14. Such a corrupted local node 14 then may exhibit apparently pristine behavior, yet perform invalid operations locally to violate the security of PDP 10 as a whole. Secondly, a user 12 is assumed to be capable of nontrivially corrupting any single node 14 which is non-local (a possessing node 18), given enough time and sufficient resources, which are easy to acquire. Such a corrupted non-local node 14 may then behave in the same fashion as a corrupted local node 14.

PDP 10 may be implemented as a peer-to-peer network. This peer-to-peer design provides scalability and data integrity, while centralized backup and indexing servers (discussed in more detail presently) provide reliability and data security.

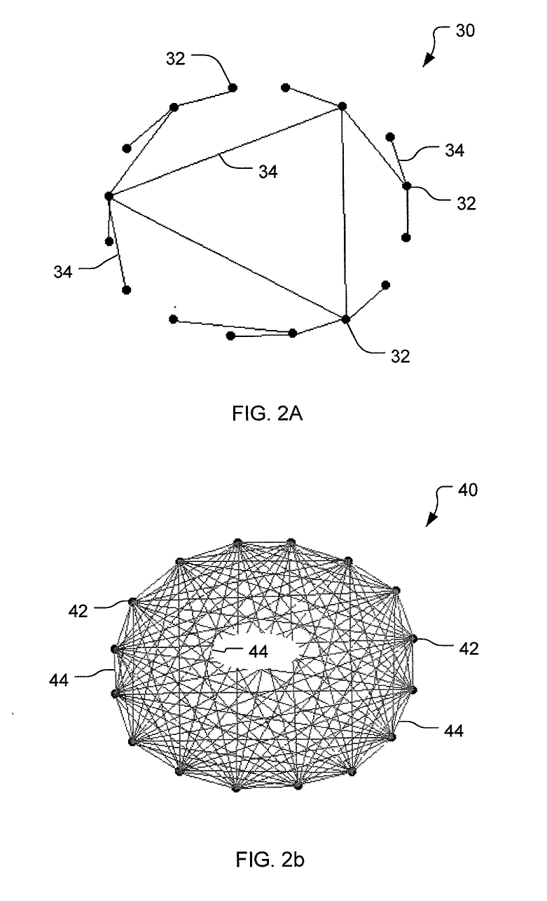

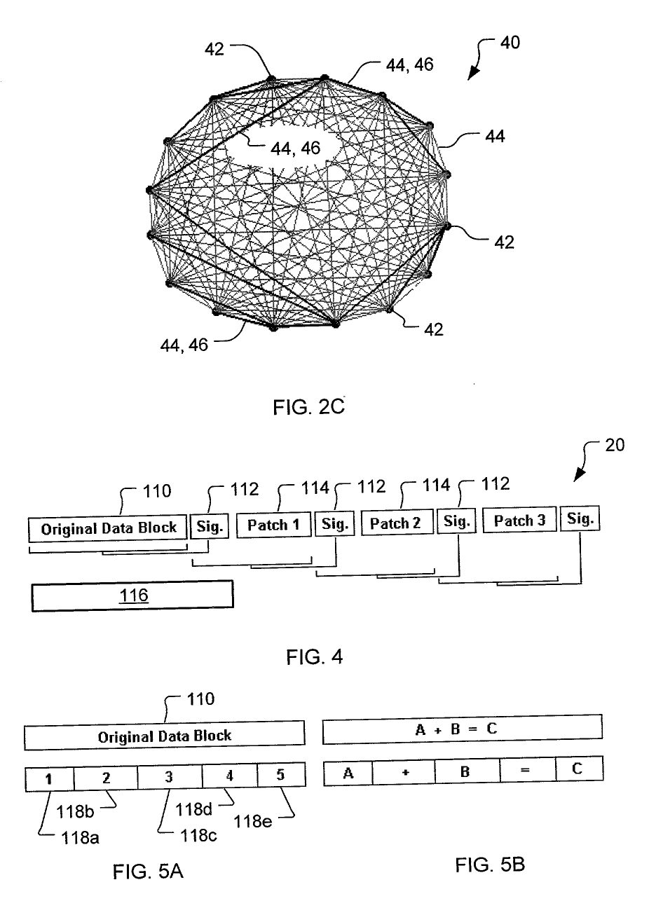

FIG. 2A (background art) is a schematic diagram depicting how the basic structure of any computer network (e.g., the Internet) can be viewed as a graph 30, consisting of computers (e.g., the nodes 14 of FIG. 1) located at the vertices 32, and network connections located at the edges 34. Data is transferred between the (nodes, computers) vertices 32 along the (connections) edges 34; often, multiple routes along the edges 34 exist for the transfer of data from one vertex 32 to the next. [It is, of course, possible to have multiple nodes 14 on the same computer, particularly in the case of multi-user systems such as Unix, Windows NT, etc. These workstations can support multiple nodes 14. It is the responsibility of the indexing node 68 to ensure that no given node 52 has as a neighbor node 56 of another node 14 on the same hardware as the given node 52.]

FIG. 2B (background art) is a schematic diagram depicting how, the network of FIG. 2A can be viewed as a separate graph 40, if the backbone of the network is designed to allow data transfer transparently from any node to any other. The graph 40 here includes vertices 42 and edges 44. The vertices 42 in the graph 40 are in the same locations and possess the same capabilities as the vertices 32 in the graph 30, but the graph 40 here is a fully-connected graph. [A fully-connected graph is one in which every node is connected directly to every other node. If an edge represents a connection having the ability to transfer data between two nodes, it is reasonable to consider the Internet to be a virtual fully-connected system.]

FIG. 2C (background art) is a schematic diagram depicting how, additionally, some of the edges 44 in the graph 40 may be weighted edges 46, according to virtual connection speed, bandwidth, and reliability. [Because the graph 40 is a representation of a virtual fully-connected network as opposed to a physical fully-connected network, edge weights do not represent the capabilities and reliabilities of physical network connections. Rather, they represent the reliabilities and capacities of a data transfer operation across the network backbone from one node to another. It is important to remember that this transfer may in fact proceed through multiple intervening nodes and across a seemingly circuitous route of physical connections (e.g., as is common in the Internet), but that the reliability of this transfer can be measured and transformed into an edge weight.]

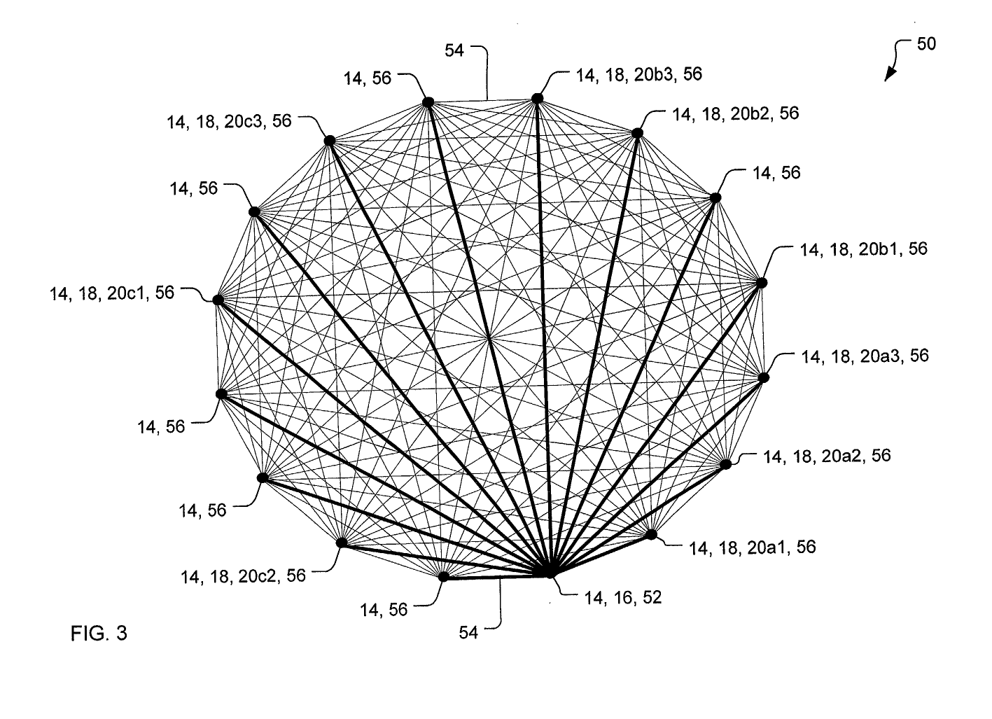

FIG. 3 is a schematic diagram depicting how, a network 50 of nodes 14 (FIG. 1) and connections 54 may be constructed atop the graph 40 of FIG. 2B-C, such that the topology of the network 50 most closely resembles that of a tree structure. This network 50 is constructed by a centralized indexing server node (described presently), which defines the relationships between the nodes 14.

A node 14 in the network 50 is defined as a computer or other processor, and is located at a vertex 42 of the graph 40. A given node 52 is shown having direct connections 54 to other nodes 14, along the edges 44 of the graph 40. On the network 50 any such given node 52 will have some number of neighbor nodes 56. Since the network 50 here is fully-connected, the given node 52 shown here has connections 54 (emphasized) to every other node 14, and all of the other nodes 14 are its neighbor nodes 56.

With reference again to FIG. 1 and continuing with FIG. 3, a basic embodiment of the PDP 10 may function as follows. A data object 20 owned by an owning node 16 is divided into a number (say, k) of data pieces (data pieces 20a, 20b, 20c here). The number of data pieces may be as few as one (k=1), meaning a sole data piece is the data object (ignoring non-data information such as signatures, permissions, etc.). Preferably, however, the number of data pieces is larger (k>1). Furthermore, each data piece may be used to make a number (say, j) of data shares according to Shamir's Secret Sharing Scheme, such that a subset of these shares (say, i) may be reassembled to reproduce the data piece.

For example, data piece 20a begets data shares 20a1, 20a2, 20a3; data piece 20b begets data shares 20b1, 20b2, 20b3; and data piece 20c begets data shares 20c1, 20c2, 20c3 (j>=1 and preferably j>=2; note that i=<j and, as presently shown, i<j is desirable and i<<j is more so). It should be noted that in FIG. 3 only three data shares per data piece are shown, due the constraint of depicting the overall data storage scheme on one page. In general, a larger number, such as j=20 will more typically be used.

The data shares 20a1-20, 20b1-3, 20c1-3 are held on the network 50 by the possessing nodes 18, specifically by neighbor nodes 56 of the owning node 16. For the data object 20 to be recovered, all (i) of its respective data pieces 20a-c must be recovered. This does not necessarily mean, however, that all of the data shares 20a1-3, 20b1-3, 20c1-3 must be recovered. For example, if i=2, the data object 20 here could be reconstructed if only data shares 20a1-2, 20b2-3, 20c1-2 where obtained, since they include the information of all (k) of the necessary data piece 20a-c and they each can be reassembled from the data shares.

This can be taken further, however. Shamir's Secret Sharing Scheme requires that only i of the original j shares are needed for reassembly, so recovery of more than i shares allows determination whether or not the recovered pieces have been tampered with. Thus, continuing with the above example, if each combination of i (in this case, i=2) data shares 20b1, 20b2, 20b3 did not all produce equivalent instances of the data piece 20b it would be clear that something was awry.

In PDP 10 data transactions may take place in accordance with this scheme. Because all data operations and transactions take place on the possessing nodes 18, movement and query operations are somewhat more complicated than on conventional networks. Again, as stated above, all operations must be initiated by the owning node 16.

FIG. 1 also depicts how the inventive PDP 10 can fulfil the requirements of secure, reliable data storage with scalability superior to a client-server architecture. The scalability requirement calls for a basic peer-to-peer architecture; however, other entries into this field have demonstrated a marked lack of reliability compared to centralized architectures. In order to address this problem, in PDP 10 a hybrid of peer-to-peer and client-server architectures may be used. This hybrid calls for two classes of nodes on the network 50: peer nodes 62 and server nodes 64. The peer nodes 62 are all equal, while the server nodes 64 have specialized purposes.

In the preferred embodiment of PDP 10 a combination of four types of nodes 14 is used. It consists of three types of computers: the peer nodes 62, computers which comprise the owning nodes 16 and the possessing nodes 18; and the server nodes 64, which comprise one or more central backup nodes 66 and one or more central indexing nodes 68. The server nodes 64 are maintained at a centralized level, while the peer nodes 62 are members of the peer-to-peer network 50. To keep things simple in this discussion, only one of each type of server node 64 is used, but sophisticated embodiments of PDP 10 can employ more.

All of the peer nodes 62 in PDP 10 are simultaneously capable of acting as both owning nodes 16 and possessing nodes 18. As stated above, the owning nodes 16 are not allowed to actually hold the data objects 20 which they own, and they have an associated group of possessing nodes 18 for that purpose.

The owning nodes 16 are responsible for all tasks associated with ownership These tasks may be broken down into two basic categories: neighbour management and data management.

For neighbor management, an owning node 16 is associated with one-thousand possessing nodes 18, by an indexing node 68 that keeps a node index 70. These possessing nodes 18 are then considered the neighbor nodes 56 of the owning node 16 and it is the responsibility of the owning node 16 to maintain records and information regarding its neighbor nodes 56.

When the owning node 16 logs onto the PDP 10, the indexing node 68 provides a current best guess status update of the neighbor nodes 56. The owning node 16 is then responsible for determining which of its one-thousand neighbor nodes 56 are online when they are needed. It is the responsibility of each node 14 to log into the indexing node 68 upon connection.

For data management, any data object 20 owned by an owning node 16 is stored on twenty of the one-thousand neighbor nodes 56 (i.e., twenty of the one-thousand neighbor nodes 56 are chosen to become possessing nodes 18). If the data object 20 is sizable enough to merit separation into multiple data pieces, or if separation is desired to enhance security, each data piece is stored on twenty of the one-thousand neighbor nodes 56. This storage is accomplished by storing one data share on each of the twenty possessing nodes 18. It is desirable that each data piece not be stored on the same set of twenty possessing nodes 18.

The owning node 16 is responsible for maintaining a data index 72 of which neighbor nodes 56 hold any particular data object 20 (or data pieces or data shares thereof) as well as access logs and other such information. It is also the responsibility of the owning node 16 to hold identifying tags for the data object 20, so that it may be retrieved by name from either the neighbor nodes 56 or the backup node 66.

The owning node 16 is also tasked with neighbour management and keeping information to determine the optimal method to retrieve the data object 20. If no neighbor nodes 56 are online, for instance, the owning node 16 may anticipate this and go directly to the backup node 66 without waiting for requests to its neighbor nodes 56 to time out.

Summarizing, all peer nodes 62 in the PDP 10 are simultaneously capable of acting as both owning nodes 16 and possessing nodes 18. The possessing nodes 18 hold the data objects 20 owned by the owning nodes 16; no possessing node 18 may own a data object 20 which it also holds. The possessing nodes 18 are responsible for protection and storage of the data objects 20. The data objects 20 owned by an owning node 16 are stored on a subset of its neighbor nodes 56. It is important to note that a possessing node 18 may also be an owning node 16, in that it may itself own data objects 20 which are possessed by other nodes 14.

Each data object 20 stored by a possessing node 18 is accompanied by an associated set of permissions, and is maintained in an encrypted state until used. When the owning node 16 of a data object 20 wishes to perform an operation on the data object 20, the possessing node 18 is responsible for verifying that such an operation is permissible. If not, the possessing node 18 does not perform the operation or allow it to be performed.

The possessing node 18 is also responsible for maintaining an index of each data object 20 which it stores. While the possessing node 18 is not allowed to know the composition or identity of any data object 20, it is responsible for maintaining a change index that will allow it to also verify that the data object 20 has not been changed illegally. This is most easily accomplished by maintaining a set of signed identification hashes verifying the file contents and last date changed.

In the event of data access to the data objects 20, certain possessing nodes 18 may be selected as the arbitrators of the access. Therefore, the possessing nodes 18 must also be capable of managing reassembly, comparison and operations on the data objects 20, i.e., as functioning as the operation nodes 22.

Note that the operation node 22 still does not necessarily have the information regarding the type or format of the data which it is assembling or operating upon; e.g., it may know that a user is permitted to add up to 30 to the contents of a data piece, but doesn't know what that data piece represents. For even higher security, PDP 10 can support permissions not as a set of definitions of impermissible operations, but rather as a set of allowed operations—in short, a small set of allowed operations can be provided to the operation node 22 as a set of scripts from which the user of the owning node 16 can then choose. Thus, the operation node 22 would have minimal information regarding the contents of data piece.

The PDP 10 may employ a central backup scheme using the backup nodes 66. If an owning node 16 cannot retrieve its data object 20 from its neighbor nodes 56, there desirably is a backup system. Unlike the owning nodes 16 and the possessing nodes 18, the backup node 66 is maintained by the network operators (presumably, a corporation), and is preferably situated on a secure location on the network 50. A backup node 66 should be capable of holding a large amount of data, but has low processor and bandwidth requirements. Because the backup node 66 is a reliability mechanism, it is responsible for maintaining a fall copy of all data objects 20 stored in PDP 10.

The backup node 66 therefore should maintain at least the same level of protection and security over the data objects 20 as the individual possessing nodes 18 do. Since the data object 20 is stored unshared on as few as one backup node 66, this node must be heavily protected against break-in. Furthermore, it must be capable of performing the same logic as the possessing nodes 18 do regarding use permissions for the data objects 20.

The PDP 10 also uses a central indexing scheme, in the form of the indexing node 68, which like the backup node 66 is preferably kept in a location protected on the network 50. The indexing node 68 is responsible for assigning and maintaining the neighbour relationships between the owning nodes 16 and the possessing nodes 18.

When an owning node 16 first attaches to PDP 10, it is assigned one-thousand nodes 14 as its neighbor nodes 56. It is the indexing node 68 that assigns these neighbor nodes 56 and maintain records of the relationship. Because assignment of neighbor nodes 56 is a potentially vast security hole, the indexing node 68 must be protected against security violations.

When each owning node 16 logs onto PDP 10, the indexing node 68 updates the owning node 16 with information regarding the current location of each of their one-thousand neighbor nodes 56, including their logon status and the length of time that they have been online. This allows the owning node 16 to determine which of its neighbor nodes 56 are available.

FIG. 4 is a schematic diagram depicting how the data objects 20 may be stored in a highly structured fashion to permit version control, authentication, logical access, and security. Each data object 20 consists of an original data block 110 having a signature 112, and potentially also a set of patches 114 that also each have signatures 112. A set of permissions 116 is also provided.

For version control, the original data block 110 published by the owning node 16 may exist for the entire lifetime of the data object 20. This data block 110 is digitally signed by its creator, with one signature 112, for purposes of authentication (see below).

When changes are made to the data object 20 through write operations, the original data block 110 is not changed. Instead, a new patch 114 and another signature 112 for it are appended to the end of the data object 20, representing a modification of the data object 20. This allows the version history of the data object 20 to be accessed easily. Alternately, if an unauthorized user 12 makes a modification, the owning node 16 can easily remove that modification. Because patching the data object 20 does not modify the original data block 110 or its signature 112, the original authenticity of the data object 20 can still be verified. Mechanisms may be used to combine a data block 110 and a set of patches 114 together into a new data object 20, say, to condense storage. This will typically be used sparingly, however, and then only when there are indicia that it can be done securely (e.g., when an oft patched data object has been static for some time or when the old data object has been securely archived).

For authentication, each data block 110 or patch 114 is signed with a signature 112 after being shared, using a standard digital signature technique. At any time, any share can be verified authentic by confirming the digital signature. Each signature 112 consists of a hash over the previous signature 112 and the new data (patches 114), encrypted using the private key of the creator. Effectively, the signatures 112 are chained together, guaranteeing that the new version is valid if the previous version was valid.

For logical access, each data object 20 stored within PDP 10 may be separated into logical elements before being shared and encrypted. For example, a sentence might be separated into words, or an equation into variables. These logical elements are stored in constant sized data blocks, allowing the possessing nodes 18 to control access to the blocks on a per block basis.

When owning nodes 16 request data from the possessing nodes 18, they are able to request that the possessing nodes 18 modify or return the value stored in a particular block in a data object 20. The possessing nodes 18 are then able to determine whether or not an owning node 16 has permission to perform that operation on the specific block requested. However, the possessing nodes 18 know nothing about the semantic structure of the data object 20, only the permissions 116 for each block which they possess. The original creator of the data object 20 would provide the permissions 116 in the original data block 110, which would be trusted due to the original signature 112.

FIG. 5A-B are schematic diagrams depicting two simplified examples of this. In FIG. 5A the data block 110 consists of five fields 118a-e. These might, for instance, be a database account record in which field 118a is a unique index, field 118b is a company name, field 118c is the company's address, field 118d is its credit limit, and field 118e is its current balance. The permissions 116 will then dictate what can be done with these fields, and by whom. The field 118a should be essentially non-editable, since it should never change. The fields 118b, 118c should be easily readable, and perhaps not even have any limits set for that operation. Modifying field 118c will be common, but needs to be limited to some reasonable scope. Modifying fields 118b, 118d will be rare, and thus typically limited to a narrow scope of supervisors. Modifying field 118e will be common, but typically limited to a vary narrow scope of users, say, only to accounting clerks.

Each data object 20 (i.e., data piece or share, as a data block 110 and possible patches 114) stored on a possessing node 18 is secret and may be doubly encrypted. The owning node 16 publishing the data object 20 originally creates the data pieces or data shares and encrypts them with its private key. The encrypted results are then distributed to the possessing node 18, that then may further encrypt them with their private keys before storing them. Thus, even if the possessing nodes 18 collude to defeat this secret sharing scheme they cannot read a data object 20, and an owning node 16 also cannot read the data object 20 even if it is illicitly retrieved from the possessing nodes 18. A data object 20 taken illicitly taken from the possessing nodes 18 can only be read if the attacker possesses encryption keys from both the owning node 16 and the possessing nodes 18.

For legal access, each possessing node 18 decrypts the requested piece of the data object 20 with its key and sends it to the owning node 16. The owning node 16 then decrypts the pieces of the data object 20 with its key and, if stored as multiple pieces, reassembles the data object 20. The possessing nodes 18 will only send pieces of the data object 20 to the owning node 16 if it has permission to access those pieces.

With reference again primarily to FIG. 1, storage in PDP 10 can be considered as a secure caching scheme for data stored on the central backup node 66. Under this model, the peer nodes 62 provide the cache. When an owning node 16 needs to read a data object 20, it first attempts to read from the cache by finding three possessing nodes 18 to provide the needed data shares. Any possessing nodes 18 with out-of-date data shares update their pieces from the backup node 66, in precisely the same fashion as a conventional cache updates from a central memory. Until a future write invalidates the cache, subsequent read operations will not impact the backup node 66.

Most caching systems today are constructed assuming that the cache is always available. To fit the needs of a peer system where nodes enter and leave the system frequently, the inventors have modified this model to accommodate the possibility of the nodes 14 here in PDP 10 being offline at the time of a write operation. Two additions to a basic caching system are required for this: version control and delayed updates.

For version control, standard caching schemes utilize a simple flag attached to the cache to track whether or not data is current. This flag is modified whenever the data is written. In PDP 10, however, the possessing nodes 18 may be offline when writes occur, and then later online when reads occur. If the possessing node 18 was offline at the time of a write, there is no way for it to know that its piece of a data object 20 is now invalid.

Since any given data object 20 is only ever properly accessed by one owning node 16, it is possible for that owning node 16 to keep a version number for the given data object 20. Every time the data object 20 is written, the version number is incremented, and the online possessing nodes 18 can record the new version number. When requesting a data object 20 from the possessing nodes 18, the owning node 16 provides the version number. Those possessing nodes 18 that were online at the time of the write have that version number, and know that their pieces are current. Those possessing nodes 18 that were offline at the time of the write will have an earlier version number, and thus know that their pieces are out-of-date. In PDP 10 this version number system replaces traditional cache flagging schemes.

For delayed updates, standard caching schemes depend on the cache being online at all times; when data is written, the cache may be updated simultaneously. In PDP 10, however, when an owning node 16 performs a write operation, there may not be enough online neighbor nodes 56 to serve as possessing nodes 18 and satisfy the request.

In this case, the owning node 16 proceeds to write to the available possessing nodes 18, and selects additional offline neighbor nodes 56 to total twenty possessing nodes 18 for the data object 20. These selected offline possessing nodes 18 are considered to be out-of-date, and will have incorrect version numbers.

On read operations, one of these selected offline possessing nodes 18 may be requested to provide its piece of a data object 20 to the owning node 16. If so, that possessing node 18 is able then to immediately determine that the owning node 16 has requested a data object 20 that is out-of-date.

When any possessing node 18 receives a request for an out-of-date data object 20, it requests an update from the central backup node 66. The backup node 66 dynamically constructs an appropriate data object 20 from its copy and updates the possessing node 18 with the new version and version number. This permits the possessing node 18 to respond to later read requests.

Unfortunately, each delayed update that occurs results in a load on the backup node 66, equivalent to reading the data object 20 (or share) directly from the backup node 66. If many possessing nodes 18 are offline, this could potentially cause significant additional server load. In this case, the owning node 16 can write directly to the backup node 66, and not request data from the possessing nodes 18. This ensures that even when very few possessing nodes 18 are online, load on the backup node 66 never becomes worse than the load which a server in a conventional central server would see.

The delete operation must be treated as a special case. As stated above, information and data objects 20 modified by write operations may be updated the next time a data object 20 is read without difficulty. However, if a data object 20 is deleted, it will never be read again. If possessing nodes 18 were offline, they would never be instructed to delete their data objects 20 (data piece or data shares). The data objects 20 would then remain in perpetuity, both wasting storage space and offering potential security risk.

Having the indexing node 68 (typically by means of a logon service running there) cache delete instructions issued by the owning node 16 solves this problem. When a possessing node 18 that missed a delete operation logs on, it will receive instructions to delete the appropriate data object 20 (data or data share).

The PDP 10 only needs a few operations to function. The nodes 14 must be able to log in, and after that they need to read, write, and delete the data objects 20. All other operations that use the data objects 20 can be composed of these three basic operations.

The PDP 10 is largely built around the read operation. It is presumed that there are a disproportionate number of read operations compared to write and delete operations. One of the key advantages offered by PDP 10 lies in servicing a vast majority of read operations from the peer nodes 62 without affecting the server nodes 64. The read operation is designed to maintain data consistency and reliability without sacrificing performance, even under erratic conditions in the network 50. Much of this is achieved through the caching scheme (described above) and careful coordination with the logon process and the write operation.

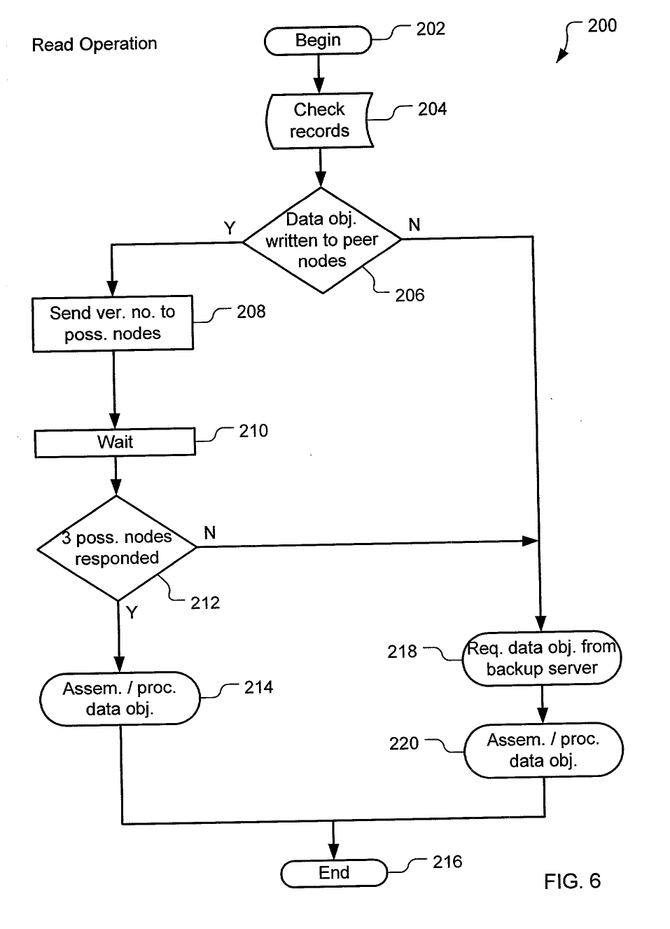

FIG. 6 is a flow chart depicting a read process 200 that may be used when an owning node 16 wants to read a data object 20 which it owns. The read process 200 begins in a step 202.

In a step 204, the owning node 16 checks its own records to determine the identity of the nodes 14 where the data object 20 was last written and the current version number of the data object 20.

In a step 206, the owning node 16 determines from the information retrieved in step 204 if the data object 20 was last written to possessing nodes 18. Typically, the data object 20 will have been written to those of its neighbor nodes 56 currently serving as possessing nodes 18.

If the determination in step 206 is in the negative and the data object 20 was last written only to the backup node 66, most of the read process 200 may be skipped and processing may continue directly at step 222 (discussed presently).

In contrast, if the determination in step 206 is in the affirmative and the data object 20 was written to possessing nodes 18, in a step 208 the owning node 16 then attempts to contact the possessing nodes 18 believed to be online. As part of this it transmits the version number of the required data object 20 to those possessing nodes 18.

If the owning node 16 believes (according to its neighbour index, which was updated when it logged onto the indexing node 68) that fewer than three possessing nodes 18 are currently online, it may also skip the peer request and request the data object directly from the backup node 66.

In a step 210, the owning node 16 waits while the possessing nodes 18 that are available respond. Any possessing nodes 18 determining that they have outdated versions of the data object 20 may retrieve an update from the backup node 66 before responding.

In a step 212, the owning node 16 determines, based on the responses it receives in step 210, if there are at least three possessing nodes 18 that have provided the data object 20.

If the determination in step 212 is in the affirmative, in a step 214 the data object 20 is assembled and processed as desired. Each possessing node 18 which replies sends its data share to an operation node 22, which may be either the owning node 16 or a possessing node 18, depending on the permissions associated with the share it possesses. In a step 216, the read process 200 is now complete.

With reference again to step 212, if the determination there is in the negative and three possessing nodes 18 have not responded, i.e., the request has timed out, in a step 218 the owning node 16 requests the data object 20 from the backup node 66. The backup node 66 then strips the headers that it has used to make the data object 20 into hard data, and it sends the data object 20 to an operation node 22. The operation node 22 may be either the owning node 16 or even the backup node 66, depending on the permissions associated with the data shares. The operation node 22 can then process it accordingly in a step 220. Finally, again in step 216, the read process 200 is complete.

Because cache misses on read operations constitute a heavy load on the central server nodes 64, the write operation attempts to avoid designating neighbor nodes 56 that will likely have out-of-date data to be used as possessing nodes 18. A 1000⊃20⊃3 scheme is employed to accomplish this: with two percent of all users 12 of PDP 10 online, the expected number of the assigned one-thousand neighbor nodes 56 online for any given owning node 16 is twenty. The write operation thus forces a possessing node 18 to be out-of-date only when there are not enough neighbor nodes 56 online to hold twenty copies of a data object 20 (or twenty data share copies of each data piece). Thus, the 1000⊃20⊃3 scheme reduces the number of possessing nodes 18 created with out-of-date data.

The 1000⊃20⊃3 scheme here also facilitates read operations. If only three possessing nodes 18 can provide their data shares for the data object 20 (or particular data piece thereof), that is adequate for assembly of the data object 20 (and more than three permits a majority vote security check). Of course, other quantities can be used than those in this 1000⊃20⊃3 scheme. The inventors have determined, however, based on an analysis described below, that these values are appropriate for many embodiments of PDP 10.

The write operation in PDP 10 subsumes the concepts of modify (change existing data) and publish (create new data), as modify can be best implemented as a delete operation followed by a write operation. This results because write is optimised to avoid future cache misses. The odds of a specific set of twenty possessing nodes 18 being online (namely, the ones that currently have the data) are much lower than finding twenty arbitrary nodes 14 out of a pool of one-thousand. Therefore, trying to make possessing nodes 18 constant per data object 20 over time would result in a higher rate of cache misses.

Optimally, the modify process would consist of a partial delete followed by a partial write, in which those possessing nodes 18 currently online would be modified and those not online would be scheduled for deletion and replaced by a new set of online possessing nodes 18 which would be written to.

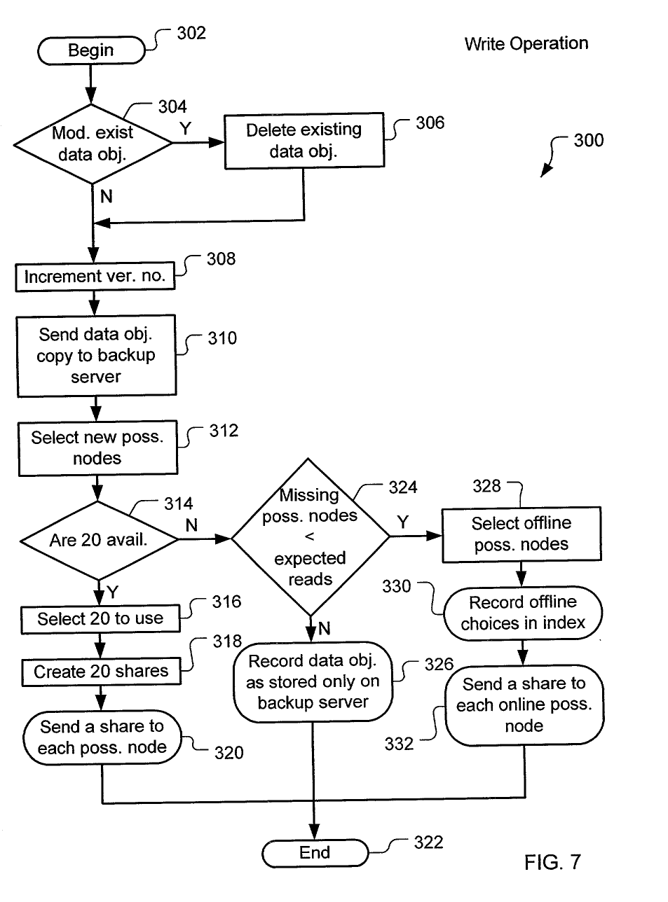

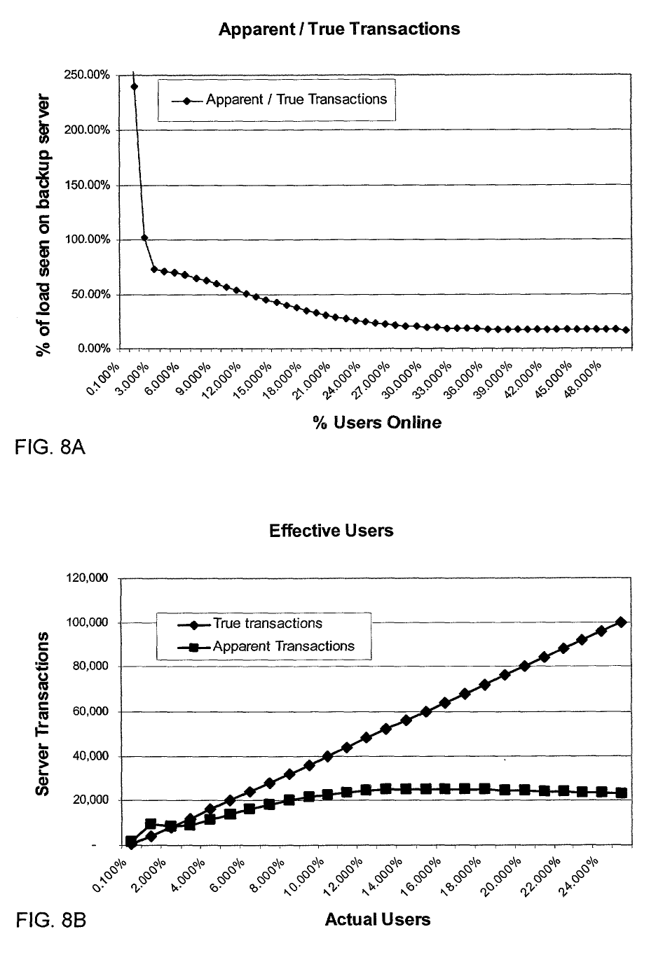

FIG. 7 is a flow chart depicting a write process 300 that may be used when an owning node 16 wants to write a data object 20. The write process 300 begins in a step 302.

In a step 304, the owning node 16 determines if it is modifying an existing data object 20, verses creating a new one. If this determination is in the affirmative, in a step 306 the owning node 16 issues a delete command for the existing data object 20. In contrast, if the determination here is in the negative, step 308 is proceeded to directly.

In step 308 the owning node 16 increments the version number of the data object 20. In a step 310 the owning node 16 sends a copy of the data object 20 to the backup node 66.

In a step 312, the owning node 16 selects a candidate pool of its neighbor nodes 56 that are available to be the possessing nodes 18. For example, any neighbor nodes 56 known to be off-line are simply not included in this pool. To facilitate pool selection, the owning node 16 may then also iterate through the neighbor nodes 56 in groups of fifty, even forming the groups in order of expected likelihood of their being online. For each member of each such group, the it owning node 16 sends a request for acknowledgement. Each neighbor node 56 that acknowledges, verifying that it is online, can then be placed into the candidate pool.

In a step 314, the owning node 16 determines if there are at least twenty neighbor nodes 56 available in the candidate pool, to become possessing nodes 18.

If the determination in step 314 is in the affirmative, in a step 316 the owning node 16 selects twenty neighbor nodes 56 from the candidate to become possessing nodes 18. (This may be done arbitrarily or may be optimised in various straightforward manners.)

In a step 318, the owning node 16 creates twenty copies of the data object 20 (i.e., twenty data shares for each data piece, wherein a data piece may be an entire data object 20 or a fragment of one).

In a step 320, the owning node 16 sends one copy and the version number to each possessing node 18, and records the node IDs of the new possessing nodes 18 for this data object 20 in its local data index 72 (FIG. 1). [If, for any reason, sending any of the copies fails, the owning node 16 can remove that neighbor node 56 from the data index 72, select a replacement neighbor node 56 from the candidate pool to become a possessing node 18, and try again. If there are no replacement candidates available, the write process 300 can return to step 310 and continue with the next group (although, instead of a twenty member pool, only as many nodes as failed are needed).] In a step 322 the write process 300 is now completed.

With reference back to step 314, if the determination there is in the negative and less than twenty candidate neighbor nodes 56 were found to be available, in a step 324 the owning node 16 compares the number of candidates still needed with the expected reads per write and determines if more candidates are needed than there are reads expected before the next write.

If the determination in step 324 is in the negative, having the backup node 66 fulfil the reads itself will be easier than having it cache misses. Then, in a step 326 the owning node 16 marks its local data index 72 to indicate that this data object 20 is stored only on the backup node 66. And in step 322 the write process 300 is again completed.

In contrast, if the determination in step 324 is in the affirmative and there are fewer candidates needed than expected reads, servicing the cache misses will be cheaper than servicing reads directly from the backup node 66. Then, in a step 328, the owning node 16 arbitrarily selects enough neighbor nodes 56 from the pool of offline neighbor nodes 56 to bring the total number of possessing nodes 18 to twenty. The possessing nodes 18 selected in this step 328 will, of course, automatically be out-of-date but they are brought up to date as the use of the PDP 10 progresses. (This selection may also be done arbitrarily or optimised in various straightforward manners.)

In a step 330, the owning node 16 records all twenty node IDs for the selected possessing nodes 18 in its local data index 72.

In a step 332, the owning node 16 makes and sends one copies of the data object 20 and the version number to each possessing node 18 that is available.

If sending to any possessing nodes 18 fails, these can be considered out-of-date. If the total number of possessing nodes 18 now out-of-date exceeds the expected reads per write, the local file index can be changed to use the backup node 66 for this data object 20. Note, however, it is possible in failure modes to do redundant work by sending copies to neighbor nodes 56 and then deciding to use the backup node 66 instead. Finally, again in step 322 the write process 300 is completed.

The delete operation removes files from PDP 10. While overall the simplest operation, it must be performed on each possessing node 18, even though the data object 20 will never be requested again. Because of this complication, part of the deletion process occurs when each possessing node 18 logs in to PDP 10.

The delete operation behaves as follows. The owning node 16 looks up in its local data index 72 which nodes 14 have the data object 20 being deleted. This can be just the backup node 66, but more typically will be both the backup node 66 and some possessing nodes 18. The owning node 16 then attempts to contact the backup node 66 and all of the possessing nodes 18 and instruct them to delete the data object 20.

For any possessing nodes 18 that cannot be contacted, the owning node 16 informs the indexing node 68 of the data object 20 and the node IDs of the non-available possessing nodes 18. The next time those possessing nodes 18 log in, they are instructed to delete the given data object 20.

Logging on and off of PDP 10 are not operations per se, but these follow a distinct process and provide assistance for other operations. The indexing node 68 therefore provides a central logon service that performs verification of nodes 14 at logon, it is the arbiter of peer pools of nodes 14, caches delete commands, and it keeps a best guess about which nodes 14 are online. Most nodes 14 can be expected to log off gracefully, providing notification to the indexing node 68, but some will disconnect suddenly and not do this.

The indexing node 68 keeps the node index 70 (FIG. 1), with which it can fulfil its various responsibilities. These include verifying the identities of the nodes 14, maintaining IP addresses for the nodes 14, informing each new node 14 which of its neighbor nodes 56 are likely online, informing the nodes 14 logging in whether they need to delete any data objects 20 they are holding, and providing the nodes 14 with various other information.

A process for a given node 52 to log on to PDP 10 may proceed as follows. The given node 52 connects to the indexing node 68 and its logon service. The given node 52 then goes through a verification process to verify its identity. The indexing node 68 looks up, in its node index 70, the peer pool of neighbor nodes 56 for the given node 52. An update packet is then created and sent to the given node 52.

The indexing node 68 checks its node index 70 for the peer pool of the given node 52 to see if each neighbor node 56 in that pool is believed to be online. If so, this is noted. The most recent logon time of the neighbor nodes 56 are also noted, since the given node 52 will likely want to use this to optimise its write operations later. The indexing node 68 then gets the current IP addresses of the neighbor nodes 56 from the indexing node 68. The indexing node 68 also looks up, in its own records, any data objects 20 which the given node 52 needs to delete (i.e., delayed deletes in the given node 52 needed in its role as a possessing node 18). All of this is information is placed in the update packet destined for the given node 52.

The update packet is then sent to the given node 52. Since the given node 52 needs the update packet to behave correctly, this step must complete before the indexing node 68 starts telling other nodes 14 that the given node 52 is online. Furthermore, the given node 52 should also ignore all requests from other nodes 14 until it processes the update packet.

Finally, the indexing node 68 notes the current IP address of the given node 52 and the time of the logon, for future use. On average, about one-thousand other nodes 14 will have the given node 52 in their own peer pools of neighbor nodes 56, and thus will receive the last logon time of the given node 52 in their own update packets.

Usually, when the given node 52 normally logs off of PDP 10 it will inform the indexing node 68 before being disconnected. However, it is possible for the given given node 52 to disconnect abruptly (say, by the user 12 telling the modem to disconnect, or due to hardware failure, etc.) without letting the logon service of the indexing node 68 becoming aware of the event. For performance reasons, the nodes 14 do not maintain a perpetual connection to the logon service, and a dropped connection cannot be detected. This is in contrast to a conventional central server system, where clients are always doing business with the server and the server can detect dropped connections. In PDP 10, the peers that the given node 52 is connected to would detect a dropped connection. In theory, they could then notify the indexing node 68 that the given node 52 had disconnected, but this would present a serious security hole, as it would be trivially easy to lie about the given node 52 being offline.

A process for the given node 52 to log off of PDP 10 proceeds as follows. The given node 52 informs the indexing node 68 that it is logging off. The indexing node 68 then verifies that this node 14 is in fact the given node 52. Note that without this it would be trivially easy to spoof IP addresses and log off arbitrary nodes 14. The indexing node 68 next deletes the IP address for the given node 52, and it further records that the given node 52 is offline, for potential later use. Finally, the given node 52 physically disconnects from PDP 10. Note that the indexing node 68 need not attempt to notify any other nodes 14 that the given node 52 has gone offline, due to the system load which that would impose.

In summary, the core of PDP 10 is the indexing service of the indexing node 68, which maintains reliability and structure. This coordinating element allows PDP 10 to dynamically grow and shrink in a controlled fashion. The central indexing node 68 is preferably maintained by the operators of PDP 10 and is best situated behind a firewall or other security mechanism.

As described above, the first time an owning node 16 enters PDP 10, the indexing node 68 assigns it one-thousand other nodes 14 to act as neighbor nodes 56. These nodes 14 are assigned from among all those that are registered with PDP 10, whether or not they are currently online. (Care must be taken in this step not to overload any particular node 14 by assigning it as a possessing node 18 for too many owning nodes 16. The indexing node 68 is responsible for maintaining a count of how many owning nodes 16 are using each node 14 as a neighbor node 56.) The indexing node 68 at this time also creates an account for the owning node 16 in its node index 70.

The node index 70 contains at least the following data for each record: an identification tag for the node 14 (i.e., a public encryption key); a current IP address for the node 14; a current status of the node 14 (logged-on, logged-off, or disabled); the time of the last logon or logoff; and a list of pointers to records for neighbor nodes 56 of the node 14.

At any point thereafter an owning node 16 may log on to PDP 10 by communicating to the indexing node 68 its current IP address and a signed verification package which allows the indexing node 68 to determine its identity. The current IP address of a node 14 is required because many nodes 14 will be connected through ISPs that use dynamic IP addressing. The indexing node 68 replies to this logon with a list of the neighbor nodes 56 for the owning node 16 (excluding those that have been disabled). Each entry in this list contains the following information: a current IP address for the neighbor node 56; a current status of the neighbor node 56 (logged-on or logged-off); and a time and date of last logon or logoff.

From this information the owning node 16 should be able to determine which of its neighbor nodes 56 are online, and where to access them. Note that in compliant applications the nodes 14 will formally log off of the indexing node 68 before disconnecting, which will make the predictive logic in the owning nodes 16 substantially easier to implement and more powerful.

When PDP 10 is in off-peak hours, the indexing node 68 can utilize its spare processing cycles to clean up the node index 70. Any nodes 14 that have been inactive for sufficient time are marked as “disabled”. Any nodes 14 having too high a proportion of neighbor nodes 56 that are disabled may then be updated with new neighbor nodes 56, returning their reliability and success rates towards system norms.

Another task which the indexing node 68 can perform is node cauterization, whereby rogue or corrupted nodes 14 are identified and cauterized, or eliminated from PDP 10. This cauterization can take the form of anything from warning other nodes 14 against trusting the rogue node to dropping the rogue node permanently from PDP 10, forcing its user 12 to completely be reinstalled in PDP 10.

The benefits of this cauterization are increased security and insurance against attack. If PDP 10 is capable of detecting the common types of rogue nodes, a cauterization operation permits it to automatically protect itself from the dangers such present.

There are, however, some problems with using too basic a cauterization scheme. If any single node can initiate a cauterization, PDP 10 is vulnerable to denial-of-service attacks; an attacker could corrupt a single node, then use it to cauterize all other nodes in the network, effectively destroying PDP 10. It is therefore necessary to have a series of checks and balances, and there are various approaches to this. For example, the indexing node 68 may record suspected rouge activity, such as non-unanimous possessing node 18 votes, and analyze these to determine patterns of questionable node activity over time. Before a cauterization command is issued multiple nodes 14 can also be required to agree. Various factors in how aggressively to use in cauterization may also be given consideration. The identity of the owning node 16 and the permissions set for the data object 20 are just two such factors.

While the central indexing node 68 is responsible for indexing and maintaining status information on every node 14 in PDP 10, it is not responsible for any indexing tasks relating to the data objects 20. Instead, it is the responsibility of each individual owning node 16 to maintain its own data index 72 (FIG. 1) to keep track of its data objects 20.

Each owning node 16 is responsible for choosing twenty nodes 14 out of its one-thousand neighbor nodes 56 to store each of its data objects 20. It is neither necessary nor desirable that every data object 20 be stored on the same twenty neighbor nodes 56; in fact, given the most likely distribution of node logons and logoffs over time, it is reasonable to expect that this will not be possible.

Within its data index 72 an owning node 16 stores the following pieces of information for each data object 20: an identification tag, the IDs of the possessing nodes 18 storing the data object 20; private and public encryption keys for the data object 20; and the logical structure of the data object 20.

When operations are performed, the owning node 16 uses the logical structure of the data object 20 to issue commands to the neighbor nodes 56 holding that particular data object 20.

Of the twenty shares of the data object 20 stored on possessing nodes 18, three must be assembled to recreate the data object 20 (or any of its characteristics, in the case of a query operation). The owning node 16 is responsible for predicting which possessing nodes 18 out of the twenty holding the data object 20 will be online and responsive, or, in the worst case, predicting that two or fewer will be accessible. (In this case, the owning node 16 contacts the backup node 66 to retrieve the data object 20 directly from it.)

A key capability in PDP 10, from a marketing perspective, is data portability—the ability to control a protected, unique digital object from any one of a number of nodes without the need to move it around from computer to computer. Thus, a change made from one computer would be present when the user 12 arrived at the next computer, and so forth.

In order to achieve this in current embodiments of PDP 10, the inventors have made use of the collaborative data solution developed by Groove Networks. This peer-to-peer technology allows multiple users 12 on multiple nodes 14 to collaborate on a single document (i.e., data object 20)—or, more importantly, allows a single user 12 to use multiple computers (i.e., nodes 14) to work on the same document.

In PDP 10, the ownership information and encryption keys for a particular data object 20 take the place of the document in the Groove system. The user 12 is able to specify any number of nodes 14 in PDP 10 upon which he or she has accounts as locations from which the data object 20 may be accessed. The ownership information is shared between these nodes 14. From that point on, the user 12 may access the data object 20 from any of those nodes 14 without difficulty.

Embodiments of PDP 10 should hold to three key tenets: security, flexibility, and reliability. Security and flexibility are addressed by the system design; reliability, however, must be maintained through careful attention to system upkeep. Furthermore, the initialization of the embodiment should allow for various entries and re-entries into PDP 10. With these tenets in mind, embodiments of PDP 10 may be designed to allow simple, independent system initialization and robust system maintenance.

A technique for constructing and initializing PDP 10 may be demonstrated in the following way. First, a small embodiment of PDP 10 may be trivially constructed manually, through explicit statement of networks of nodes 14 and cryptosystem keys. This embodiment would be sufficiently large for a small amount of traffic to pass. Second, a technique for adding a single node 14 at a time to an existing PDP 10 is constructed. Adding as many nodes 14 as required, one at a time, may then create a PDP 10 of arbitrary size. A node 14 entering the PDP 10 for the first time should undergo the following steps.

In a first step, discovery and logon takes place. The new node 14 connects to the indexing node 68 and obtains a new identity and account in the index. The indexing node 68 provides a new serial number to the node 14, as well as a list of one-thousand neighbor nodes 56 on which the node 14 may store data objects 20, and a list of other owning nodes 16 that may store data objects 20 on the new node 14.

In a second step, encryption keys are generated. The new node 14 generates public and private encryption keys for secure communications and identity verification.

In a third step, keys are traded. The new node 14 trades encryption keys with its new neighbor nodes 56 (if any are online). The new node 14 also establishes an account with the backup node 66, so that it can store data objects 20 there.

Finally, in a fourth step, client software is obtained or updated and work begins. The new node 14 can now download and install any new software or patches since release and can begin work. The new node 14 is now able to store data objects 20 in PDP 10.

Any data storage system requires occasional updates in the form of patches, bug fixes, security corrections, etc. Peer-to-peer systems, however, are more difficult to update because the system administrators do not have control over the hardware in the system.

Fortunately, PDP 10 is simpler to update than most peer-to-peer systems, because each node 14 begins its session by logging onto the central indexing node 68. Once a node 14 logs on and discovers a waiting update, the patch can be downloaded and installed using existing web-based technology. This drastically simplifies the peer update process. Updates to the backup node 66 and the indexing node 68, of course, are implemented trivially.

Over time, some nodes 14 will depart PDP 10 and others will arrive for the first time, as users 12 stop and start using PDP 10. It is the responsibility of the indexing node 68 to maintain PDP 10 in the face of this phenomenon. Obviously, new peer nodes 62 logging onto PDP 10 for the first time will be assigned other new peer nodes 62 as neighbor nodes 56; however, it will be desirable to enforce a mingling of new and old peer nodes 62 for the sake of security.

During off-peak hours, the indexing node 68 examines its records to determine which peer nodes 62 have not logged onto PDP 10 for a substantial time. If a peer node 62 has not logged on in a long time, it is marked inactive (disabled). If any owning node 16 has enough inactive neighbor nodes 56 that the performance of PDP 10 might be degraded, the indexing node 68 can assign it new neighbor nodes 56 to bring it back up to a full complement of one-thousand presumably active neighbor nodes 56. Finally, the indexing node 68 can reassign unused neighbor nodes 56 between the owning nodes 16 to ensure an even distribution of old and new neighbor nodes 56.

The following definitions are useful in the following discussion of computation of the performance of PDP 10. A “read/write ratio” is the ratio between read and write operations in PDP 10. In most embodiments, there will be significantly more read operations than write operations, so the ratio will be significantly greater than 1:1 (10:1 or more is not uncommon).

In many respects, PDP 10 is a caching system. Like all caching systems, it dramatically speeds up read operations at the expense of slowing down write operations. As long as the read/write ratio is high, this results in performance gains. However, if this ratio is sufficiently low for a given application, PDP 10 will suffer a loss in performance.

A “user correlation factor” describes the patterns in the behaviour of most users 12. Many users 12 will log on at the same time each day and perform similar activities each time that they log on. This means that user populations are usually highly correlated: a large number of the other nodes 14 that are online when a given node 52 logs on now will be there again when that same given node 52 logs on the next time. This is measurable with the user correlation factor.

The inventors refer to the set of correlated users as a core population. PDP 10 does well if the core population is a significant percentage of the total user population. PDP 10 works reasonably well if the population is uncorrelated. There is not much change in behaviour as correlation goes up to 5% of the populace. There is then a dramatic improvement as the core goes to 20% of the total and very little change after that point. The inventors expect that 10-15% of the total user base will consist of this core population in the real world.

“Apparent transactions” are the number of transactions that the server nodes 64 handle. The peer nodes 62 will handle most transactions; these transactions will never affect the load on the server nodes 64. Thus only a small portion of the total set of transactions will be apparent to the server nodes 64. This offers a metric for loads on the server nodes 64 that can be compared to other technologies.

The “percent of users online” is also informative. The total user 12 population is the set of all people that have active accounts in PDP 10. These users 12 employ PDP 10 frequently, store data objects 20 in it, and hold data objects 20 for other users 12. Only a portion of this total population will be online at any given time. This proportion varies strongly by application. For example, ULTIMA ONLINE typically sees 10% of its users online, with 20% at peak usage times. News websites, on the other hand, generally have less than 1% of their users online at any given time.

PDP 10 depends on being able to find data objects 20 on the possessing nodes 18. The data objects 20 are placed on the possessing nodes 18 somewhat randomly, so the chance of finding any particular piece of a data object 20 is dependent on the percentage of users 12 that are online when the data object 20 is requested. The total size of the population is unimportant when determining whether a piece of a data object 20 will be found, so many graphs and analyses may be productively viewed in terms of percent of users online, rather than total population size.

An “amortized server load” is also informative. As stated above, the inventors' research indicates that most embodiments of PDP 10 will have between 10% and 15% of their users 12 online at any given time. In this range, the apparent server load is between 75% and 45% of the total load, or the load the server would support with existing client-server technology. This clearly represents a significant improvement over existing purely server-based solutions.

FIG. 8A and FIG. 8B are graphs depicting that the characteristics of PDP 10 break even with existing client-server technologies at 2% of the users 12 online, and become more efficient as that percentage climbs. When 20% of the users 12 are online, the server node 64 only receives 30% of the total load, and so forth. In the graphs, a “true transaction” is an operation performed by a user 12 and an “apparent transaction” is the load on the server node 64 by a true transaction.

In PDP 10 the existence of the backup node 66 ensures that data objects 20 are available at all times. This approach, in fact, possesses greater reliability than standard client-server systems, since even conventional servers have some small downtime. The existence of the network in PDP 10 of the peer nodes 62 thus provides greater reliability than the backup node 66 alone possesses.

A simple modification of PDP 10 is to remove the backup node 66 entirely. The reliability of such an embodiment is illustrated by the graph in FIG. 8A. The PDP 10 here would function in exactly the same way, except that there would be no backup nodes 66 to query in the case where the data object 20 could not be recovered from the network of peer nodes 62. The line indicates the number of requests that would fail to find data objects 20. A PDP 10 with no backup node 66 would result in a data store with approximately 45% reliability.

In a conventional client-server environment the true and the apparent transactions would be the same. The advantage of PDP 10 over such a conventional environment is readily apparent in the graph in FIG. 8B.

PDP 10 provides particular value in applications that fit the following criteria. What data can be stored in PDP 10 is one such criteria that requires consideration. The data is valuable only while online, since the data objects 20 are inaccessible in PDP 10 if the possessing nodes 18 are offline. PDP 10 does not protect data that must be local on the owner's PC to be used, such as audio, video, or software. The value of the data must be its attributes, not the content itself. PDP 10 also does not protect data that needs to be fully reassembled locally.

PDP 10 does not generally provide for execution upon the data objects 20. It is therefore unsuitable for data that particularly must be retrieved for execution on the local node 14 of a user 12, since an data object 20 is unprotected there. PDP 10 also provides no advantage for server-based execution.

The data objects 20 in PDP 10 cannot be embedded or integrated into other systems easily. For example, PDP 10 cannot protect stock photographs embedded into a brochure, or medical record information stored in a mainframe.

If the data is voluminous, a portion of it could be stored locally to alleviate bandwidth concerns but still provide sufficient security. The remote portion then would be a data object 20 constituting only part of a larger object.

The environment in which PDP 10 operates also requires consideration. The applications which will use PDP 10 already require software to be installed on the user's computer. PDP 10 requires local software, and cannot simply be run through a browser. The barrier to adoption will thus be lower if an application is already installing software, and PDP 10 then is a transparent addition.

Under PDP 10 the users 12 stay at one computer, or a few pre-determined computers. PDP 10 does not inherently have the ability for users 12 to logon at arbitrary nodes 14 without having designated those in advance. The neighbor nodes 56 can be picked from a community of users 12, with similar hours of operation. Preferably 10-15% of the users 12 are online at the same time. The existence of “super-peers” is very helpful (neighbor nodes 56 that are generally online, reliable, have good performance, and have a history of being trustworthy). PDP 10 can, at least initially, be focused on WINDOWS PCs connected with TCP/IP networks.

PDP 10 does not require network management for quality of service, since it is harder to manage a peer-to-peer network than a server-based network.

An application suitable for PDP 10 should require more security than can be provided on local data. For example encryption and digital signatures are now sufficient for legally binding documents, not requiring PDP 10. The additional security provided by a firewall and physical security is unwarranted, however, and the publishing user 12 should have sufficient confidence in PDP 10 to distribute their data objects 20.

Potentially, PDP 10 can provide increased anonymity compared to a server approach, keeping data objects 20 from a central authority. For some applications this is a liability, such as the US Treasury Department tracking and auditing requirements for digital cash. It may, however, be an advantage in some other applications.

PDP 10 can be a source of advantages in applications. If the total volume of read accesses are a burden on a server, and distributing those accesses reduces the bandwidth at the server, significant savings can result. PDP 10 does not reduce the bandwidth for authentication, write or delete operations, but applications characterized by a massive volume of reads can achieve significant savings. Note that only the bandwidth reduced for read operations provides advantage. PDP 10 will not provide savings on the server for storage space or execution. PDP 10 is best for data that requires no manipulation, for which there are large volumes of read requests incurring significant bandwidth expenses, and which meets the technical boundaries defined above.

In summary, PDP 10 has the potential to reduce server costs for applications that meet specific requirements. If the data and environment meet certain constraints, then significant bandwidth savings accrue.

The strength of security in PDP 10 comes from the unique manner in which it divides and stores data objects 20 on multiple possessing nodes 18, and the resilience to attack of individual computers acting as these possessing nodes 18. By preventing the owning nodes 16 from possessing the data objects 20, a verification layer can be inserted between the user 12 and the data objects 20 for all accesses. This allows enforcement of user-level access control, even through the data object is not necessarily on the secure central backup node 66. As long as the users 12 are kept from having a complete copy of their data objects 20, permissions can continue to be enforced. Therefore, the primary security violations are those that allow the owner of a piece of data to access his or her data directly, especially outside the bounds of PDP 10.

PDP 10 may make use of several published algorithms. While a full discussion of the relative merits of the algorithms in each of these areas is beyond the scope of this discussion, a discussion of the basic concepts of the classes of algorithms is now presented. The algorithms fall into two major categories: encryption and secret sharing algorithms.

The inventors' present embodiment of PDP 10 relies on three families of algorithms from cryptology. Key agreement protocols and a private-key cryptosystem are used to establish secure channels of communication, and a message digesting and signing algorithms is used in order to ensure the integrity of the communications themselves. These algorithms ensure communications security and data integrity.

The purpose of key agreement protocols is for two parties (e.g., nodes 14) to determine a secret key over an insecure channel (e.g., a network). Currently, the Diffie-Hellman algorithm is one of the better-known algorithms for key agreement. This algorithm operates efficiently and is mathematically secure.

Once two nodes 14 utilizing a key agreement protocol have mutually decided upon a key, a secure cryptosystem must be used to protect the communications between the nodes 14. Two forms of cryptosystem are available for this purpose: public- and private-key systems.

Private-key cryptosystems, also known as symmetric cryptosystems, utilize a single key that is known to the sender and the receiver, and must be kept secret from all third parties. These cryptosystems are characterized by their high speed and small size: they are very quick to implement. In PDP 10, private-key cryptosystems provide communications security between the nodes 14 by encrypting the data before it flows over insecure networks.

A prime example of a private-key system, and one which we consider suitable for protecting the communications within PDP 10, is Rijndael. Rijndael is the National Institute of Science and Technology's (NIST) proposed replacement for DES (Digital Encryption System). Rijndael was selected for two reasons: it was secure, and it could be used to encrypt data faster than that data could be sent over a LAN, with very low CPU load. Rijndael can be used to encrypt data for transmission in real time. Furthermore, it is small enough to function on smart cards and other small devices. At this time, the inventors consider communications between the nodes 14 of PDP 10 to be adequately protected if Rijndael is used.

Public-key cryptosystems are known as asymmetric cryptosystems because they utilize two keys—one private and one public. In public-key cryptology, only the message recipient knows the private key, while the public key may be distributed freely. Messages may be encrypted with the public key, but may only be decrypted with the private key, allowing far greater flexibility than private-key cryptosystems.

The downside of public-key cryptosystems is their low speed and long key lengths. Public-key cryptosystems are substantially weaker for a given key length than private-key systems. Furthermore, public-key cryptosystems require a substantially longer time to encrypt and/or decrypt a message than their private-key counterparts. For this reason, public-key systems work poorly with long messages.

Because of the disparity in speed between private-key and public-key cryptology, it is desirable that communications in PDP 10 is primarily secured through the faster private-key systems. Public-key cryptosystems are reserved for data signatures and identity verification.

In order to verify that a message is authentic, it is necessary to have some form of digital signature attached to the message. As noted in the discussion of public- and private-key cryptosystems, public-key systems perform poorly on long messages. As a consequence, the current best practice in this area is to create a message digest and sign that digest using the private key from a public-key cryptosystem. This allows anyone who receives the message to decrypt the digest using the sender's public key. Then, they can apply the digest algorithm to the message and verify that the message originated from the correct person and has not been tampered with in transit. Some good algorithms for this application are the MD-2, MD-4 and MD-5 algorithms for generating secure collision-resistant hashes, which were developed at RSA Labs by Ron Rivest and the RSA public-key cryptosystem for signing the digests.

Secret sharing is one of the fundamental underlying technologies of PDP 10. It allows us to mathematically guarantee that no one node 14 can read a data object 20 without requesting data shares from several other nodes 14 in the network. Shamir's secret sharing algorithm is one of the best currently in the field; it is outlined below.

The algorithm works as follows: consider the data that you wish to store as a floating-point value s. We will represent s as the y-intercept of a polynomial. Select the number of people that are required in order to assemble the secret; call this number k. Select the number of people who will receive a portion of the secret; call this number n. We will construct a polynomial of degree k with y-intercept s, and with its other coefficients randomly selected. Then we will select n random points on that polynomial and distribute one point to each of the n people who will hold the secret s. It should be no surprise that with k−1 points specified, the polynomial's y-intercept is completely undetermined, and that with k points specified, the entire polynomial is determined.

Secret sharing with compression is a variation on Shamir's secret sharing algorithm where we use all but one of the coefficients of the polynomial to encode a secret value. By using this modification, we can achieve more efficient data storage. We believe that this leaves all of the algorithm's other properties unchanged.

Furthermore, we will optimise the implementation by identifying each node that is to hold data with a single x value. Thus, each node will only store one x value, and a y value for each polynomial, reducing the storage requirements by half. When these two are used in combination, we achieve data compression.

In particular, the inventors like to use a

$$( \begin{matrix}20 \\ 3\end{matrix} )$$

secret sharing scheme. This means that quadratics are used as polynomials, so two data elements per polynomial can be stored. The size of a data element is the same as the size of the y value at a point, so we are transforming two data elements into one y value of the same size as either data element, achieving 50% compression. If we were using a larger share, we would gain better compression. For example, in an

$$( \begin{matrix}n \\ 9\end{matrix} )$$

system we would be able to transform 8 data elements into one point, and achieve 87.5% compression in each share.

Note that the size of each share is reduced, although the total amount of data is increased. Although each share is smaller by 50%, we have produced 20 shares, so the total amount of data is 10 times what it would be without secret sharing. In a

$$( \begin{matrix}24 \\ 9\end{matrix} )$$

system, the total amount of data would be 3 times the original, although it would be divided among 24 different computers (possessing nodes 18).

While various embodiments have been described above, it should be understood that they have been presented by way of example only, and not limitation. Thus, the breadth and scope of the invention should not be limited by any of the above described exemplary embodiments, but should be defined only in accordance with the following claims and their equivalents.

### Industrial Applicability

The present Peer Data Protocol (PDP 10) is well suited for application in storing data reliably and securely. As has been described herein, its server nodes 64 may be limited to an indexing node 68 and, optionally, a backup node 66. Its peer nodes 62 then are the owning nodes 16 and possessing nodes 18, which can interchangeably serve in both data owning and storing roles.

The reliably of PDP 10 exceeds that of conventional central server based approaches, since the backup node 66 and the possessing nodes 18 compliment to provide the data objects 20 when either is unable to.

The security of PDP 10 also approaches that a conventional central server approach. The underlying scheme of distinguishing data ownership and possession is buttressed by encryptions, signatures, piece-wise separation, and share-wise analysis.

The scalability of PDP 10 is particularly notable. It inherently grows and shrinks as peer nodes 62 join or withdraw, and log in or log out. Each peer node 62 comes to PDP 10 as both a potential owning nodes 16 with its own data objects 20 to be stored, and as a possessing node 18 to store data objects 20 for others.

The inventive PDP 10 may be implemented with current skills and technologies. Its server nodes 64 are essentially conventional in nature, and applying to implement the invention should be straightforward to those skilled in the computer networking arts. Similarly, the peer nodes 62 may be entirely convention hardware, with the addition of a software client that should be straightforward to those skilled in the computer programming arts.

For the above, and other, reasons, it is expected that the PDP 10 of the present invention will have widespread industrial applicability and that its commercial utility will be extensive and long lasting.

What is claimed is:

1. A system for securely storing a data object, comprising:
a computerized owning node that owns the data object;
a plurality of computerized neighbor nodes, wherein said owning node and said neighbor nodes are distinct and are collectively members of a network in which they have peer-to-peer status; and
a plurality of possessing nodes that store the data object, wherein said plurality of possessing nodes is a subset of said plurality of said neighbor nodes, thereby securely storing the data object away from its said owning node.

2. The system of claim 1, wherein a data piece derived from the data object is assigned to be stored by each said possessing node, wherein each said data piece is all or part of the data object and all said data pieces assemble into the whole of the data object.

3. The system of claim 2, wherein multiple data copies derived from each said data piece are stored by different said possessing nodes, thereby permitting comparison to determine if security of any said data piece has been compromised.

4. The system of claim 2, wherein multiple data shares derived from each said data piece with a sharing algorithm are assigned to different said possessing nodes for storage, wherein said data pieces may each be assembled from less than all of said multiple data from which they are respectively derived.

5. The system of claim 4, wherein:
one-thousand said neighbor nodes are assigned to said owning node to be said plurality of neighbor nodes;
twenty said data shares derived from each said data piece are assigned to said possessing nodes for storage; and
at least three said data shares must be assembled.

6. The system of claim 1, further comprising an indexing node to store information about said neighbor nodes, wherein said indexing node is also a member of said network.

7. The system of claim 6, wherein said indexing node assigns said plurality of neighbor nodes to said owning node.

8. The system of claim 7, wherein:
said neighbor nodes each log into said indexing node when joining said network; and
said information stored by said indexing node includes the current known availability of respective said neighbor nodes.

9. The system of claim 8, wherein said plurality of possessing nodes assigned to store the data object are chosen based on said information about availability of said neighbor nodes;

10. The system of claim 9, wherein said indexing node provides said information about availability of said neighbor nodes to said owning node.

11. The system of claim 10, wherein said owning node chooses said plurality of possessing nodes assigned to store the data object.

12. The system of claim 1, further comprising a backup node that is also a member of said network, wherein said backup node stores a copy of the data object and is available as a server to provide said data pieces as an alternate for retrieving the data object than said possessing nodes.

13. The system of claim 12, wherein:
said possessing nodes storing the data object each have a respective peer data piece derived from the data object; and
said backup data piece is compared with said peer data piece.

14. The system of claim 12, wherein:
said possessing nodes storing the data object each have a respective peer data piece derived from the data object; and
said backup data piece is used in place of one said peer data piece.

15. The system of claim 14, wherein said backup data piece is used in place of one said peer data piece when any said peer data piece is deemed untrustworthy or unavailable.

16. A method for securely storing a data object, the method comprising the steps of:
(a) constructing a network of computerized nodes, wherein one said node is an owning node that owns the data object and a plurality of said nodes are neighbor nodes that are distinct from said owning node;
(b) assigning a plurality of said nodes to be possessing nodes, wherein said plurality of possessing nodes is a subset of said plurality of said neighbor nodes;
(c) storing the data object on said plurality of possessing nodes, thereby securely storing the data object away from its said owning node.

17. The method of claim 16, wherein said step (c) includes:
creating at least one data piece from the data object, wherein each said data piece is all or part of the data object and all said data pieces assemble into the whole of the data object; and
storing said data pieces on different said possessing nodes.

18. The method of claim 17, wherein said step (c) includes:
making multiple data copies of each said data piece;
storing each said data cop y on a different said possessing node; and
upon access to the data object, comparing said data copies to determine if security of any said data piece has been compromised.

19. The method of claim 17, wherein said step (c) further includes:
deriving multiple data shares from each said data piece with a sharing algorithm, wherein said data pieces may each be assembled from less than all of said multiple data from which they are respectively derived; and
storing said data shares on respective said possessing nodes.

20. The method of claim 19, wherein said sharing algorithm is Shamir's secret sharing algorithm one-thousand said neighbor nodes are assigned to said owning node to be said plurality of neighbor nodes, twenty said data shares derived from each said data piece are assigned to said possessing nodes for storage, and at least three said data shares must be assembled.

21. The method of claim 16, further comprising:
(d) monitoring availability on said network of said neighbor nodes.

22. The method of claim 21, wherein said step (a) further includes picking said plurality of neighbor nodes with respect to said owning node based on said availability.

23. The method of claim 21, wherein said step (c) further includes selecting said plurality of possessing nodes from among said plurality of neighbor nodes based on said availability.

24. The method of claim 23, wherein said owning node selects said plurality of possessing nodes to store the data object.

25. The method of claim 16, further comprising:
(d) providing a backup server on said network; and
(e) storing a backup copy of the data object on said backup server, thereby providing an alternate means for retrieving the data object than said possessing nodes.
